(19) United States
(12) Patent Application Publication
(10) Pub. No.: US 2017/0216917 A1
(43) Pub. Date: Aug. 3, 2017

(54) SENSORS AND PROCESS FOR PRODUCING SENSORS

(71) Applicant: Forschungszentrum Juelich GmbH, Juelich (DE)

(72) Inventors: Yanil ZHANG, Beijing (CN); Robert VABEN, Herzogenrath (DE); Daniel Emil MACK, Koeln (DE); Georg MAUER, Toenigvorst (DE); Oliver GOUILLON, Juelich (DE)

(21) Appl. No.: 15/501,239

(22) PCT Filed: Jul. 16, 2015
(86) PCT No.: PCT/DE2015/000356

§ 371 Date: Feb. 2, 2017

(30) Foreign Application Priority Data
Aug. 8, 2014 (DE) 10 2014 011 552.6

(51) Int. Cl. B22F 3/105; B23K 26/12; B23K 26/20; G01P 15/00; G01K 7/16; G01L 9/08; G01L 1/00; B23K 26/00; B23K 26/70

(52) U.S. Cl. CPC B22F 3/1055; B22F 3/105; B23K 26/0006; B23K 26/123; B23K 26/20; B23K 26/706; G01K 7/16; G01L 9/08; G01L 1/005; G01P 15/00; B22F 2201/11; B22F 2203/11; B22F 2301/10; B22F 2301/052; B22F 2301/205; B23K 2201/36

(57) ABSTRACT

A method for producing a sensor on the surface of a functional layer, in which suitable sensor material in the form of powder or a wire is melted in a laser beam by way of a method similar to laser cladding and subsequently is applied to the surface of the functional layer. There is provided a considerably improved method for producing sensors, and in particular in-situ sensors, wherein the sensors can also be deposited onto a functional layer that, in part, is very coarse, without having to employ complex masks, as has previously been customary. The ease of adapting the method parameters ensures broad use both with respect to the sensor to be produced and the functional layer to be detected. The sensors thus produced are used, in particular, to detect components that are subject to high temperatures or the functional layers thereof. The sensors that can be produced in accordance with the invention include, in particular, temperature, pressure or voltage sensors, as well as acceleration sensors.

The invention relates to sensors in general, and in particular to embedded sensors, which are disposed on or within a functional layer. The invention furthermore relates to a method for producing such sensors.

### PRIOR ART

Sensors are suitable for measuring specific properties of an environment. Sensors are passive in contrast to actuators, which serve to modify the environment.

In particular, in processes in which high temperatures and large flows of heat occur, it is extremely important to check and monitor process parameters. To the extent that critical process parameters can be recorded in real time (in situ), it is possible to detect disturbances and problems that occur immediately and implement appropriate solutions, possibly directly while the processing cycle is still in progress.

At present, what are known as “intelligent coatings” are already being produced and used for the purpose of the in-situ monitoring of turbine blades in operation, which can advantageously detect the load state in situ, which is to say in real time, and thus allow the operating conditions to be adapted.

In intelligent coatings, the sensors are often advantageously disposed (embedded) directly within a functional layer. It is advantageous for the service life of the functional layers if the microstructural properties of the functional layer in the direct vicinity of the sensors are changed as little as possible, and the structural sizes of the sensors are minimized to the extent possible, so as to generate only minimal thermomechanical stresses in the functional layers, which are generally brittle.

Previously, embedded high-temperature sensors have been produced by way of thermal spraying methods, sputtering by ion bombardment, or arc deposition. The fineness of the sensor structures is typically generated either by way of masks, which initially must be applied onto the substrate in a complex process, or by way of collimators, which are accordingly introduced into the material stream. Both methods drastically limit the application efficiency.

The previously used methods have in common the need to limit the heat input to the substrate/component, which results in damage to the functional layer or component above critical rates.

### Problem and Solution

It is the object of the invention to provide interruption-free and substantially dense sensor structures for high-temperature use, which can be present embedded on, or also advantageously in, a functional layer disposed on a component (substrate), without significantly impairing the thermomechanical properties of the surrounding functional layer, and moreover advantageously can also be read out directly in-situ, which is to say in real time.

It is a further object of the invention to provide a method for producing such sensor structures, which is considerably simpler and thus more cost-effective than the previously known production methods for sensors for this purpose.

The invention is achieved by a method for producing sensors according to the main claim, and by sensors according to the additional independent claim. Advantageous embodiments of the method and of the sensors can be found in the respective dependent claims.

Subject Matter of the Invention

The present invention relates in general to the provision of sensor structures (sensors) for high-temperature use, and to a method and a process for producing the same. High-temperature use shall be understood to mean temperatures greater than 500° C., and in particular temperatures up to approximately 1500° C. Typical orders of magnitude for the functional layers are in the range of 200 μm to 3 mm. The sensor structures provided have structural sizes that are considerably smaller than the functional layer thicknesses, and in particular sizes typically in the range of 50 to 500 μm. In particular, the present invention relates to a novel production method, in which one or more corresponding sensors are applied directly onto a functional layer or are embedded within a functional layer, and wherein the production is carried out by way of a method similar to laser cladding, without the use of masks. A functional layer shall be understood in particular to mean a thermally highly loaded component, frequently having a complex shape.

Within the scope of the present invention, a sensor or a sensor structure shall be understood to mean a structure generated from lines, which is able to qualitatively, or quantitatively, detect certain physical or chemical properties, such as temperature, pressure, acceleration or stress in the immediate surroundings thereof. A sensor converts these measured quantities into an electrical signal, such as a voltage, which can be easily captured from the sensor by way of cables. To this end, the sensor can either be designed to be electrically conductive or generate voltages itself in the form of a ceramic sensor (piezo effect).

For example, metallic thermistors or PTC thermistors, in which the internal resistance changes with the temperature and which typically comprise metals, metal oxides or also semi-conductors, are suitable temperature sensors that are able to detect the absolute and/or relative temperature, or also temperature differences, in the immediate surroundings. Furthermore, thermocouples shall be mentioned as sensors in which two materials, typically metals, having differing thermal EMFs are connected and generate a voltage correlating with the temperature.

Sensors for detecting pressure, stress or forces within a layer typically comprise piezoelectric elements, such as ceramic materials (for example, perovskites, such as BaTiO₃), which are able to convert longitudinal changes or shear forces within the environment into an electrical signal. Furthermore, thermistors or PTC thermistors, in which the effective resistance changes under elastic deformation and which typically comprise metals, metal oxides or also semiconductors, are used to detect pressure and stresses.

An “in-situ” sensor, within the scope of the invention, refers to a sensor that is able to detect the variables to be measured, such as the temperature, the pressure or stresses, in real time.

Within the scope of the present invention, functional layers used on a component for high-temperature use shall be understood to mean primarily protective layers, and in particular ceramic thermal barrier layers having low thermal conductivity, insulating layers, oxidation (or corrosion) protection layers to improve the resistance in an oxygen-containing or corrosive atmosphere, or environmentally stable (thermal) protective layers for fiber composites. The latter are also known by the name of thermal barrier coatings (TBC) or environmental barrier coatings (EBC). Such functional layers encompass insulating layers, for example, which are regularly used when joining SOFC batteries. Within the scope of the invention, a functional layer, however, shall also be understood to mean an arbitrary intermediate layer on a component, on which, if necessary, first a functional layer having the aforementioned functions can be disposed.

Materials that have been found suitable for these functional layers are, for example, MgAl₂O₄, Al₂O₃, TiO₂, mullite, ZrO₂, CaO/MgO and ZrO₂, Y₂O₃-8YSZ, CeO₂ and YSZ, LaZrO₇, GdZrO₇ and Y—Si—O.

The invention furthermore describes a production method in which typically one or more very small sensors, and in particular so-called in-situ sensors, are produced in or on a high-temperature functional layer. The method employs a method similar to laser cladding. The sensor is applied, in the form of appropriately suitable sensor material, onto the surface of a functional layer, wherein the application step is carried out by way of a laser. The functional layer itself has generally already been previously disposed on the surface of a component (substrate), such as a turbine blade. At 50 to 500 μm, the typical structure/line diameters of the deposited sensor structures are regularly less than half the layer thickness of the functional layer.

It is desirable that the surface properties of the substrate, and in particular of the functional layer applied thereto, are advantageously not altered, or at least are only minimally influenced, by the application of the sensor material (coating) with the aid of a laser. For this purpose, the parameters of the method, which determine the power input on the substrate, must be appropriately adapted.

According to the invention, this is ensured by weakening the direct irradiation of the focused process laser on the substrate by using a sufficiently high particulate flow rate for the powder that is delivered during the process into the working area of the laser. Meanwhile, selecting a smaller focal diameter for the laser at the height of the substrate compared to the powder allows the powder particles to be melted close to the power center of the laser.

The sensor material melted by way of a laser is deposited onto the surface of the functional layer in the form of individual lines and can advantageously be configured as a sensor there, for example in the form of electrically conductive conductor tracks. By providing additional electrical contact, the sensor can subsequently be used in this form. This is typically carried out in a region that is less subject to thermal or mechanical load. It is then also possible to create larger contact points using other methods.

In the case of a temperature sensor, for example, initially, a narrow coating (conductor track) comprising a first metallic powder can be applied onto the functional layer, which acts as a first conductor. Thereafter, a second narrow coating comprising a further metallic powder is applied onto the functional layer such that the two coatings (conductors) are electrically conductively connected via a contact point. A design that is composed of two conductors made of differing materials, which have a shared contact point, can already act as a temperature sensor.

Electrical contact for the sensor that is created on the surface of a functional layer is made, in the simplest case, by way of electrically conducting cables. In the case of a temperature sensor, so-called compensation wires can be used for this purpose, which have the same electrical properties, as a function of the respectively contacted conductor, in a permissible temperature range. During operation of a sensor, this is then generally connected via electrically conducting cables or via compensation wires to an external measuring and recording device.

In general, however, it is not necessarily provided that, subsequent to the production of one or more sensors on a first functional layer, further material is applied in a planar manner onto this functional layer and at least onto a portion of the sensor deposited thereon. Advantageously, the regions in which electrical contact is made with the sensor, or the contact is made with conductor tracks and compensation wires, can be recessed.

In this way, the sensor produced according to the invention advantageously can be entirely or partially embedded in a further layer.

This further layer can likewise be a functional layer made of similar materials as those already described for the first functional layer. Atmospheric plasma spraying, for example, is a suitable application method for the planar application of this further layer.

One advantageous embodiment of the invention also provides for multiple sensors of the same or a different kind to be applied onto a first functional layer in accordance with the invention. For example, both a temperature sensor and a stress sensor could thus be produced on a functional layer in accordance with the invention.

By subsequently applying a further functional layer, the sensors could thus be embedded simultaneously on the first functional layer.

A further advantageous embodiment of the invention provides for multiple sensors of the same or a different kind to applied not only onto a first functional layer and embedded in a further functional layer, but likewise for further sensors of the same or different kind to be applied onto this optional second functional layer in accordance with the invention.

In this way, it would advantageously be possible to produce sensors in different planes relative to the component. Relative to the component, the sensors can be disposed either directly on top of one another or also offset.

By arranging sensors in different planes within a functional layer system disposed on a component, it is advantageously possible to provide information about a property within a functional layer as a function of the distance from the component, such as a temperature curve perpendicular to the component.

In general, at least two different sensor materials are required for creating a temperature sensor on the surface of the substrate. For example, Alumel® or Chromel®, or platinum and platinum-rhodium alloys, as well as NiCr and Ni, can be used as sensor materials for the two conductor tracks. The sensor material used can generally be selected by a person skilled in the art in keeping with the expected temperature.

For the creation of a piezoelectric pressure, stress or force sensors, essentially piezoelectric ceramics (such as lead zirconate titanate ceramics (PZT)) can be used, which in general are processed in the form of polycrystalline materials by way of sintering processes, and have comparatively low melting or sintering temperatures. Compared to materials such as quartz, tourmaline and gallium phosphate or lithium niobate, they additionally have a piezoelectric constant that is generally two orders of magnitude greater. Moreover, metallic alloys (such as Ni-20Cr, Cu-45Ni, Pd-13Cr or Cu-12Mn-2Ni in percent by weight) can be used as stress or strain sensors, having an internal resistance that changes considerably under pressure or strain.

The sensor material can be supplied to the laser beam as a powder having a particulate size between 1 μm and 200 μm, which is advantageously present in the form of uninterrupted tracks, such as electrically conducting connections, after application.

In contrast to the existing application methods for similar sensors, such as thermal spraying methods, atomization by ion bombardment (sputtering) or arc deposition, in which a cover mask or a slit collimator must typically be used, the method according to the invention is a much more convenient application method for applying a small sensor made of powder onto a functional layer solely based on the time savings and, because the use of a complex cover mask is not required, considerably higher application efficiency is achieved.

Using the method according to the invention, it is possible to provide very durable sensors, which may also operate in real time, in close proximity to, or in, a layer, which themselves do not have any disadvantageous impact, or at least only to a very small degree, on this layer which they serve to monitor.

The stated problem is solved by being able to use the method according to the invention to produce what are known as intelligent coatings by applying or embedding sensors on or in functional layers, such as thermal barrier coatings or other protective layers, without the use of masks. The protection of the substrate from temperature-induced degradation is ensured by the highly focused energy input of the laser beam and the shielding thereof by the process, powder.

In an advantageous embodiment of the invention, the sensor is applied to the surface of a functional layer by way of a laser, for example, using a commercial laser cladding device.

In the method according to the invention, corresponding sensor material in the form of powder or a wire is supplied to a focused laser beam. The sensor material melted in the laser beam is then applied to the surface of a functional layer. The sensor material is used depends on the type of sensor to be produced.

The key to the method according to the invention is to match the supply rate of the powder, or the relative movement with respect to the applied wire, and the energy density of the laser to each other so that the energy input of the laser is sufficient to melt at least a portion of the supplied powder or of the wire, while beyond that additional heat input into the substrate is advantageously limited. It must be ensured that the surface temperature of the substrate during the application does not reach the melting temperature of the substrate, and advantageously even remains considerably below that.

Overall increased substrate temperature, however, can improve the adhesion between the applied sensor and the substrate in some cases, or support slow solidification of the molten sensor material on the substrate.

In one embodiment of the invention, alternatively, for example, it is also possible to dispose a wire made of the corresponding sensor material directly on the surface of a functional layer, which thereafter is melted with the aid of the laser beam on the surface of the functional layer. This method variant is also included in the method according to the invention.

After being applied to the functional layer, the powder melted in the laser beam can cool again, there on the surface, and thus form a dense coating, for example in the form of uninterrupted conductor tracks. This coating is generally punctiform or line-shaped, depending on the relative movement between the laser and the surface of the functional layer.

Since the sensor material is applied to the functional layer from a molten state, the coating advantageously exhibits a pore-free and dense structure, in which no grain or phase boundaries occur, as they would, for example, with a sintered coating according to the prior art.

In a special embodiment of the method, the application of the sensor material can moreover take place under protective gas. Application under protective gas has the advantage that oxidation processes can be substantially avoided. In particular, small particles supplied to the laser can be protected against oxidation at high temperatures.

The protective gas used can, in particular, be argon or N₂.

Depending on the selection of the sensor, both metallic and ceramic materials, or mixtures of metallic and ceramic materials, can be applied in the form of powder or wire. The powder size used is advantageously between 1 μm and 200 μm, and in particular between 2 μm and 50 μm. When a wire is used, the preferred wire diameters are in the range of 50 to 1000 μm, and in particular between 50 and 150 μm.

In a special embodiment of the method for producing a sensor, a further layer is applied onto the functional layer, and at least partially onto a sensor disposed thereon, after the sensor material has been applied to the functional layer, and optionally after the corresponding contacting for reading out the sensor. The sensor can thus be enclosed to a large extent, and can advantageously be protected. In particular, in the case of temperature sensors, external influence on the materials can result in a significant influence on the thermal EMF that is generated and should thus be substantially avoided.

The same material that was already used for the functional layer is also a suitable material for this further layer, which is to say MgAl₂O₄, Al₂O₃, TiO₂, mullite, ZrO₂, CaO/MgO and ZrO₂, Y₂O₃-8YSZ, CeO₂ and YSZ, Y₃Al₅O₁₂, LaZrO₇, GdZrO₇ and Y—Si—O. However, other materials can also be applied to the actual functional layer and the sensor or sensors, serving only as a protective layer.

Atmospheric plasma spraying, among other things, is a suitable application method for this further layer. Further suitable methods for applying this second functional layer include deposition from a gas phase, such as electron beam physical vapor deposition (EBPVD), or wet-chemical processes, such as tape casting, including a subsequent sintering step.

The layer thickness of the optionally additionally applied layer can be between 10 μm and more than 10 mm. In particular, the layer thickness can be in the range between 100 μm and 1000 μm.

The methods introduced according to the invention allow, in particular, temperature sensors, strain measuring sensors, flow sensors, acceleration sensors or similar sensors, to be produced on the surface of functional layers, such as thermal barrier coatings, insulation layers or other protective layers in a simple manner, and without the use of complex masks. In this way, it is possible to detect and evaluate the chemical and physical properties of such layers, at times even in real time.

Fields of use for the aforementioned sensors that should be mentioned are preferably those of components subject to high temperature loads, such as turbine blades or other rotor blades, as well as other machine components, in which monitoring of chemical or physical properties is desirable. It is, however, likewise conceivable to use the sensors according to the invention on components having poor electrical conductivity, such as high-performance electronics components, porous membrane carriers or battery substrates. The use of electrodes, which likewise can be produced by way of the method according to the invention described herein, in conductive layers for resistance measurement as a measure of a change or a degradation shall likewise be mentioned as an advantageous field of application of the invention.

It has been shown that a conductor track for a sensor produced in accordance with the invention can be easily distinguished from one that is obtained by way of the previously customary application methods, such as plasma spraying, using masks.

Deposition on the functional layer takes place after prior melting of the sensor material. On cooling, a very dense and pore-free conductor track thus forms. Pore-free within the meaning of the invention shall be understood to mean a material having a porosity of less than 1 vol %, and in particular of less than 0.5 vol %. A sectional view would thus not show any grain or phase boundaries. A distinction is thus possible from conductor tracks that are formed by way of a sintering step, for example, in which particles or agglomerates sinter and generally exhibit a larger porosity than mentioned above.

Moreover, the use of masks in the previously known production methods for sensors, such as plasma spraying, regularly creates conductor tracks that, due to the production process, each have very steep edges. In contrast, the conductor tracks applied according to the invention show a cross-section having an envelope, which shows rather flat edges.

In general, the characteristic cross-section of a conductor track that is applied in accordance with the invention overall shows a more arcuate progression, while a conductor track that was produced according to the prior art, in contrast, in the central region shows a flattened cross-section extending substantially parallel to the surface of the functional layer, and moreover has considerably steeper edges. This is due to the fact that plasma spraying, in principle, is a method for the planar, parallel application of material, while the method according to the invention is advantageously suitable for applying lines or spots.

In summary, it can be stated that the invention provides a considerably improved method for producing sensors, and in particular also of in-situ sensors, wherein the sensors can also be deposited onto a functional layer that, in part, is very coarse, without having to employ the previously customary complex masks. The ease of adapting the method parameters ensures broad use both with respect to the sensor to be produced and the functional layer to be detected. Advantageously, with the method according to the invention, the surface temperature of the functional layer can easily be prevented from rising above the melting temperature when the sensor is being applied, whereby the influences from sensor production can be substantially avoided.

The method according to the invention can also advantageously be used to produce in-situ sensors, which is to say sensors measuring in real time, which are able to detect the load state of the environment and thus enable a timely adaptation of the operating conditions.

The invention advantageously allows the deposition of fine line structures (sensor tracks), serving as sensor structures, which are so homogeneous or free of inclusions that electrical voltages and mechanical stresses can be transmitted without interruption/discontinuities.

### Specific Description

The invention, the particular advantages thereof, and new applications will be described in more detail hereafter based on concrete exemplary embodiments and several figures, without thereby limiting the scope of protection of the invention. A person skilled in the art is readily able, depending on the task, to select various modifications and alternatives of the method described herein, without departing from the subject matter of the invention or personally exercising inventive skill.

The method according to the invention for producing sensors can also be applied to other blades, other turbine parts or other machine parts, and the benefits of the invention are found, in particular, with steam and gas turbine blades or other vanes, which in general are exposed to a high temperature load.

### IN THE DRAWINGS

FIG. 1 shows a schematic illustration of the material supply in a device for laser cladding according to the prior art (a) and a schematic illustration of an exemplary material supply and laser focusing with the process control according to the invention (b);

FIG. 2 shows a schematic sectional drawing (a) and top view (b) onto a functional layer comprising a temperature sensor applied thereto in accordance with the invention and a further layer optionally applied thereto;

FIG. 3 shows a schematic top view onto a functional layer comprising a strain sensor applied thereto in accordance with the invention and a further layer applied thereto;

FIG. 4 shows a top view onto a functional layer comprising a K-type temperature sensor disposed thereon in accordance with the invention;

FIG. 5 shows a diagram of the temperatures ascertained by the temperature sensors as a function of the heating time, and a comparison between a sensor according to the invention and a reference sensor;

FIG. 6 shows a surface profile of a functional layer comprising a temperature sensor (a) applied thereto in accordance with the invention and a further layer (b) optionally applied thereto;

FIG. 7 shows schematic cross-sections of conductor tracks applied onto a functional layer, and a comparison between a conductor track applied in accordance with the invention and a conductor track applied by way of conventional methods; and

FIG. 8 shows a cross-sectional view of a conductor track applied onto a functional layer in accordance with the invention and embedded therein.

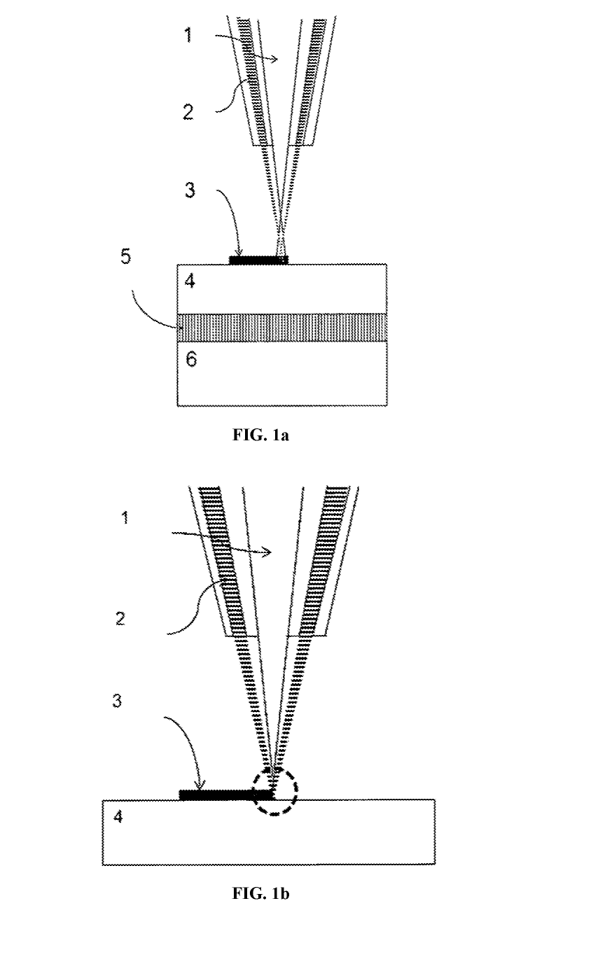

FIG. 1 schematically illustrates the application of the sensor material, as it can also be employed in the present invention. The sensor material is supplied to a laser beam, in a manner similar to that in a device for laser cladding (FIG. 1a).

The powder to be applied (sensor material) (2), which later forms the sensor, can typically be provided via a powder nozzle disposed on the side (laterally), via multiple powder nozzles disposed on the side (radially), or via a powder nozzle disposed concentrically (coaxially).

Several millimeters, such as 7 mm, can be selected as a typical distance between the functional layer and the laser.

The supplied powdery material (2), which is initially melted in the laser beam (1), is deposited on the surface of the functional layer (4), for example a ceramic insulating layer, as a coating (3), such as a metallic linear conductor, after compaction. The functional layer (4) is disposed on the metallic component (substrate) (6), such as a turbine blade, optionally via a further intermediate layer (5) (bond coat).

The control of the process can be achieved, according to the invention, for example, by selecting the focus cross-section of the powder supply (2) at the substrate level so as to be greater than the cross-section of the focused laser beam (1) (FIG. 1(b)), so that a sufficiently high powder supply rate results in considerable shielding of the substrate from the laser, and furthermore by adapting the displacement speed so that the portion of the process powder melted in the central region of the laser spot is deposited as a continuous trace having good adhesion onto the substrate, which may be rough.

As an alternative to application by way of a powder, it is also possible to supply a prefabricated wire made of the sensor material directly to the laser beam, or alternatively this can also already be disposed on the surface of the functional layer, and be melted by way of a laser to serve as a corresponding coating/conductor track (not shown in FIG. 1).

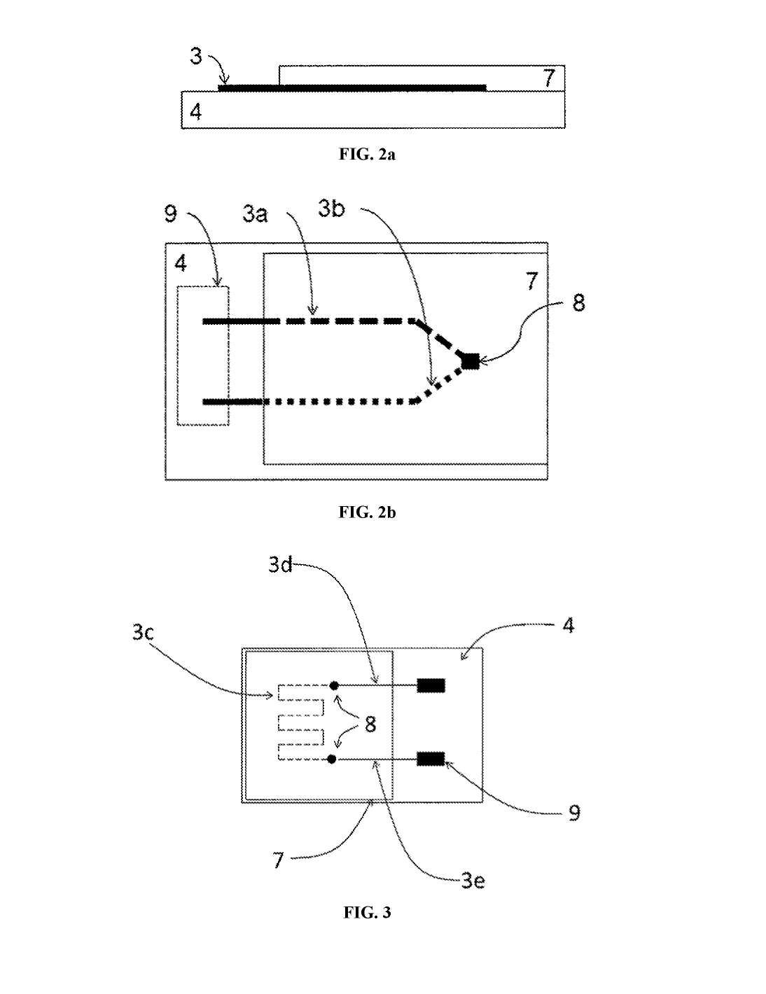

FIG. 2a shows a schematic cross-section through the functional layer (4) and the sensor (3) applied thereto in accordance with the invention. The component and an optional additional intermediate layer are not illustrated in this figure. Furthermore, a further (second) functional layer (7) is shown as one embodiment of the invention, which covers portions of the sensor and of the first functional layer, for example, while leaving the region of the contacting of the sensor (9) exposed.

FIG. 2b schematically shows the corresponding top view for the cross-section illustrated in FIG. 2a. The temperature sensor comprising the two conductor tracks (3a, 3b) is applied in accordance with the invention onto the functional layer (4) in the form of two thin sensor coatings/conductor tracks made of differing materials. The two conductor tracks are electrically conductively connected to one another at a contact area (8). The region (9) intended for external contact with the compensating lines, which is to say the ends of the two conductors of the sensor, is not covered by the further functional layer (7). Thus, they remain freely accessible,

FIG. 3 schematically shows the top view onto a strain sensor produced in accordance with the invention. The strain sensor comprising the strain-sensitive conductor track (3c), which is disposed in a meander shape, and the electrical connecting lines (3d, 3e), is applied onto the functional layer (4) in accordance with the invention in the form of thin sensor coatings/conductor tracks made of a suitable material. The conductor tracks are electrically conductively connected to one another at the contact areas (8). The region (9) intended for the external contact, which is to say the ends of the two connecting lines of the sensor, is not covered by the further functional layer (7). Thus, they remain freely accessible.

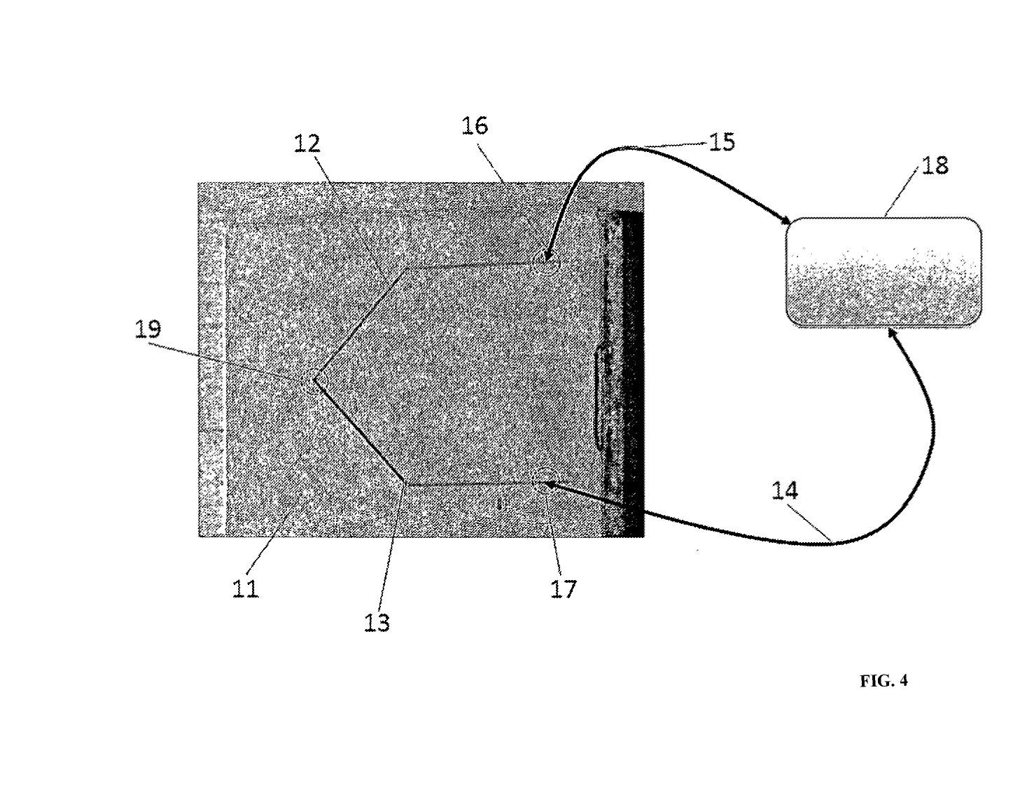

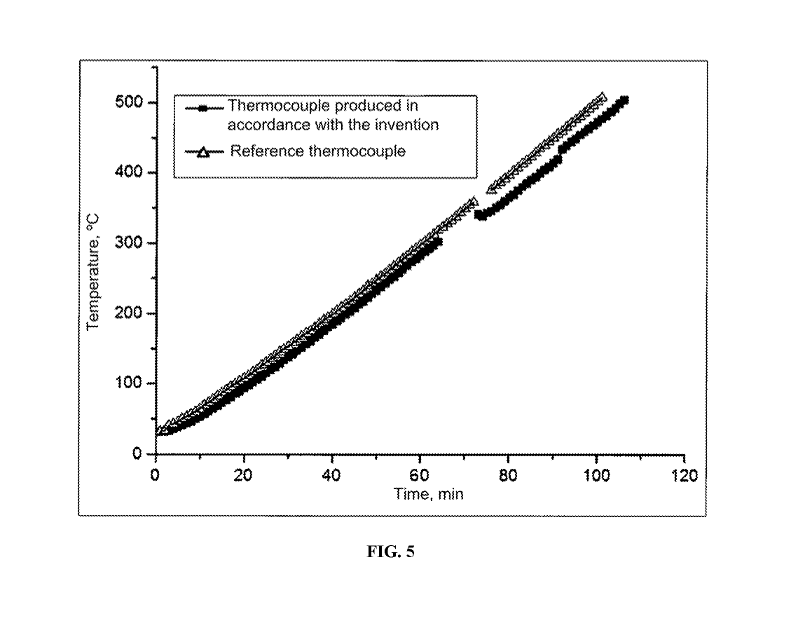

In one embodiment of the invention, the sensor was produced in accordance with the invention as a type K thermocouple (see FIG. 4 in this regard). To this end, two conductor tracks made of differing materials, in this case made of Alumel® (12) and Chromel® (13), were applied at right angles with respect to one another, on the functional layer (11) of a metallic substrate by way of a method similar to laser cladding. The two conductor tracks are electrically connected to one another via a connecting point (contact area) (19). For the conductors, appropriate powders having a particle diameter of 2.6 to 20 μm (d₅₀=7.4 μm) for Alumel® and of 3.5 to 35 μm (d₅₀=12.1 μm) for Chromel® were used.

The sensor was applied onto the functional layer (11) by way of a laser, wherein the aforementioned powders were each supplied to the laser beam via a coaxial supply system. The laser used was a neodymium-doped yttrium aluminum garnet laser (Nd:YAG) in the lower power range.

To check the functional capability of the temperature sensor and to determine the Seebeck coefficient, the thermal and electrical data of the thermocouple produced in accordance with the invention were measured at temperatures between room temperature and 500° C. To this end, the negative conductor made of Alumel® (12) was contacted with a NiAl compensating line (14), and the positive conductor made of Chromel® (13) was contacted with a NiCr compensating line (15). For contact, the compensating lines (compensation wires) were each pressed onto the positive conductor and the negative conductor (contact areas 16, 17), at some distance from the contact point, and were each fixed by way of a small glass plate and metal clamps. The other ends of the compensation wires were connected to the measuring and recording device (temperature measuring device) (18), which includes a measuring transducer/transmitter. The contact point (19) is formed by the measuring point having the measuring temperature, while the measuring device (18) integrates the comparison point having the reference temperature, which typically is the room temperature.

In addition, a commercially available type K thermocouple was disposed adjacent to the contact area (19) of the thermocouple produced in accordance with the invention and likewise connected to the measuring and recording device (18).

The sample, comprising at least the functional layer and the two thermocouples disposed thereon and connected to the measuring device (18), was heated in a furnace under an argon protective gas atmosphere at a heating rate of 5 K/min. During the experiment, voltages generated by the two thermocouples were continuously detected and evaluated by the measuring device.

FIG, 5 indicates the temperature values detected by the measuring device during the experiment over the time of the experiment. The line marked by closed symbols represents the results of the thermocouple produced in accordance with the invention, and the line marked by open symbols represents the results of the reference thermocouple. Temporary interruptions in the measuring value sequence, in particular for the thermocouple produced in accordance with the invention, are caused on the fluctuating contact resistance which, in the present experiments, are compensating lines pressed on only by means of metallic clamps.

By evaluating the ascertained voltages, it was possible to confirm that, with the sensor produced in accordance with the invention, the generated voltage has a substantially linear dependence on the temperature in the analyzed temperature range. With the aid of a linear adjustment, a Seebeck coefficient could be determined from the detected thermal EMFs as a measure of the thermoelectric sensitivity of 41.2 μV/K at a regression factor of 0.9999. In contrast, commercially available thermocouples have a nominal Seebeck coefficient of 41.1 μV/K. The comparison shows that the voltages generated by way of the thermocouple produced in accordance with the invention can be rated as very trustworthy. This experiment impressively demonstrates that the sensor according to the invention even now can be used as an excellent temperature sensor.

After this test series, a further layer, which in the present case corresponded to a ceramic functional layer, was applied by way of atmospheric plasma spraying. In this way, the sensor (3) disposed on the first functional layer (4) could be completely embedded.

In this case, the sensor is present embedded in the two functional layers. The free line ends of the sensor produced in accordance with the invention were connected, via appropriate compensating lines, to a measuring and recording device, which was able to detect the electrical signals generated during the experiment.

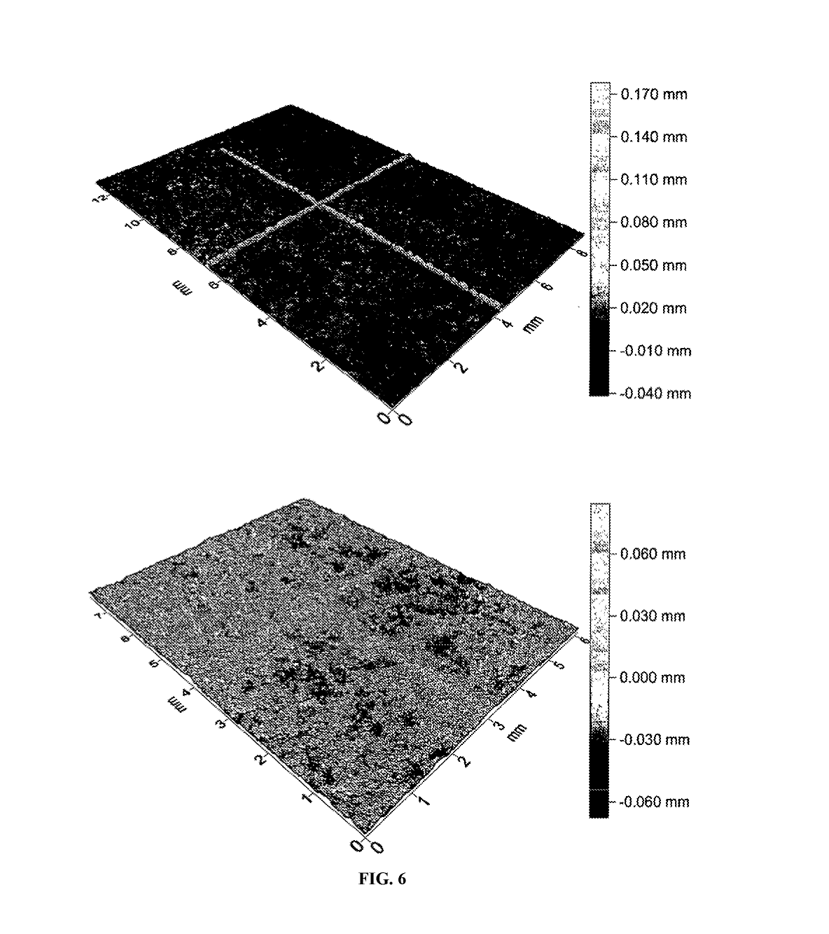

The layer thickness of the second applied functional layer was approximately 200 μm. The two functional layers were produced by way of plasma spraying and had a surface roughness of approximately 40 μm. Experiments and powerful optical measuring methods (white light interferometry) for ascertaining height profiles of an embedded sensor clearly demonstrated that, at a sensor height (height of the applied conductor track) of approximately 90 μm and a layer thickness of the second functional layer of likewise approximately 200 μm, an excess height for the second functional layer of only approximately 40 μm is apparent at the location of the conductor tracks. This demonstrates that the sensor is embedded well in a relatively thin second functional layer (see also FIG. 6 in this regard).

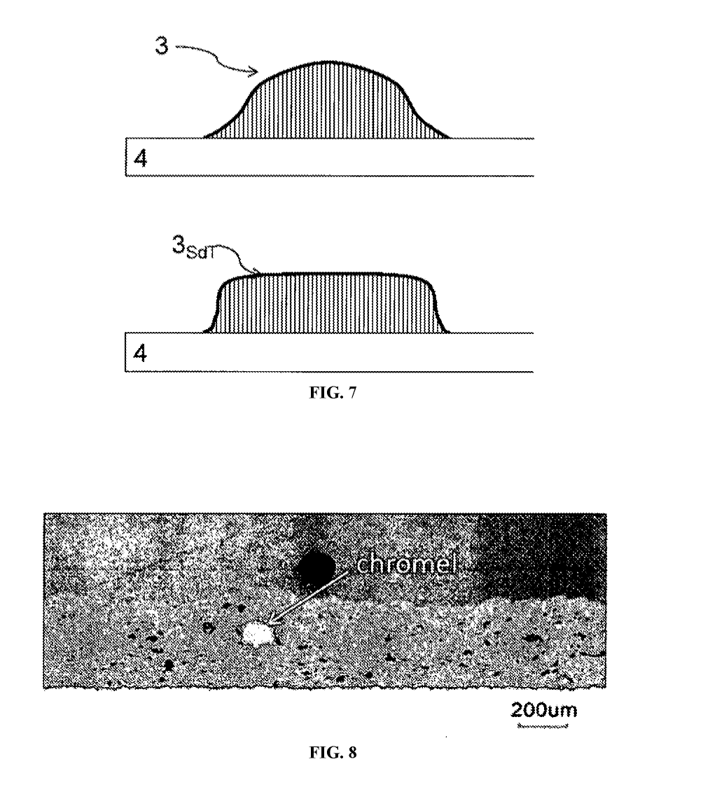

It has been found that it is easily possible for a person skilled in the art to distinguish a sensor applied or deposited onto a functional layer by way of the method according to the invention from one obtained by way of previously customary application methods, such as plasma spraying, using masks. A comparison of the different cross-sections using the example of a conductor track is schematically illustrated in FIG. 7.

The characteristic cross-section of a conductor track (3) applied in accordance with the invention shows an overall arcuate progression, while a conductor track that was applied with the aid of a mask and using conventional plasma spraying, by comparison, shows a flattened cross-section (3_{SdT}) extending almost parallel to the surface of the functional layer in the central region and has considerably steeper edges. This is due to the fact that plasma spraying, in principle, is a method for the planar, parallel application of material, while the method according to the invention is advantageously suitable for applying lines or spots. Depending on the surface properties of the functional layer and the wettability, an undercut can also be generated in the method according to the invention.

FIG. 8 shows a cross-sectional view of a conductor track applied onto a functional layer in accordance with the invention and embedded therein.

In summary, it can be stated that the invention provides a considerably improved method for producing sensors, and in particular also of in-situ sensors, wherein the sensors can also be deposited onto a functional layer that, in part, is very coarse, without having to employ the previously customary complex masks. The ease of adapting the method parameters ensures broad use both with respect to the sensor to be produced and the functional layer to be detected.

1. A method for producing a sensor on the surface of a functional layer, wherein the sensor material is at least partially melted in a laser beam using a method similar to laser cladding and is subsequently applied onto the surface of the functional layer, wherein, during the application of the sensor material, the surface temperature of the functional layer is established so as to be lower than the melting temperature of the functional layer.

2. The method according to claim 1, wherein the establishing of the surface temperature of the functional layer is achieved by limiting the heat input by shielding the process laser by way of the delivery rate of the sensor material.

3. The method according to claim 1, wherein a ceramic thermal barrier coating, an insulating layer, an oxidation (or corrosion) protective layer or an environmentally stable (thermal) protective layer is used as the functional layer.

4. A method according to claim 1, wherein the sensor material is applied under a protective gas atmosphere.

5. The method according to the claim 1, wherein argon is used as the protective gas.

6. A method according to claim 1, wherein powder having a mean particle diameter between 1 and 200 μm, and in particular between 2 and 50 μm, is used as the sensor material.

7. A method according to claim 1, wherein the structure cross-sections of the applied sensor are small compared to the dimensions of the functional layer.

8. A method according to claim 1, wherein Alumel®, Chromel®, platinum, iron, copper nickel alloys, platinum rhodium alloys, nickel chromium alloys, tungsten rhenium alloys, CrNi steel, nickel, Ni-20Cr, Cu-45Ni, Pd-13Cr, Cu-12Mn-2Ni, barium titanate or lead zirconate titanate ceramics (PZT), quartz, tourmaline, gallium phosphate or lithium niobate are used as the sensor material.

9. A method according to claim 1, wherein a temperature, pressure, stress or acceleration sensor is produced.

10. A method according to claim 1, wherein the sensor applied to the surface of the functional layer is at least partially embedded by applying a further layer.

11. The method according to claim 1, wherein a further functional layer is applied as the further layer.

12. A sensor wherein the sensor is disposed on the surface of a functional layer and having been produced by a method according to claim 1.

13. The sensor according to claim 12, wherein this is a temperature, pressure, stress or acceleration sensor.

14. The sensor according to claim 12, wherein the applied sensor material is designed to be uninterrupted and pore-free.
